(19) United States
(12) Patent Application Publication
(10) Pub. No.: US 2018/0321351 A1
(43) Pub. Date: Nov. 8, 2018

(54) WEARABLE DEVICE JOURNEY INFORMER

(71) Applicant: Ford Global Technologies, LLC, Dearborn, MI (US)

(72) Inventors: Brad Alan Ignaczak, Canton, MI (US); John Robert Van Wiemeersch, Novi, MI (US); Adil Nizam Siddiqui, Farmington Hills, MI (US)

(73) Assignee: Ford Global Technologies, LLC, Dearborn, MI (US)

(21) Appl. No.: 15/773,597

(22) PCT Filed: Nov. 20, 2015
(86) PCT No.: PCT/US2015/061905

§ 371 Date: May 4, 2018

(51) Int. Cl. G01S 5/00; G08G 1/123; G06F 1/16; H04W 64/00; H04W 4/40; G07C 5/00

(52) U.S. Cl. CPC G01S 5/0072; G08G 1/123; G07C 5/008; H04W 64/003; H04W 4/40; G06F 1/163

(57) ABSTRACT

A computing device is programmed to identify a vehicle location and a vehicle status of a vehicle. The computing device can also identify a wearable device and a location of the wearable device. The computing device can also determine, based at least in part on the vehicle status, the location of the vehicle and the location of the wearable device, at message. The computing device can also send the message.

### CROSS-REFERENCE TO RELATED APPLICATION

This patent application is filed under 35 U.S.C. § 371 as a national stage of, and as such claims priority to, International Patent Application No. PCT/US2015/061905, filed on Nov. 20, 2015 the foregoing application is incorporated herein by reference in its entirety.

### BACKGROUND

A wearable device is a computer that is incorporated into items of clothing and/or accessories, e.g., bracelets, pendants, etc., and typically can comfortably be worn on the human body. Generally, wearable devices have some form of communications capability, e.g., Bluetooth or the like, and allow the wearer access to local and global computers via a wired or, usually, a wireless, network. Data input and output capabilities are also features of such devices. Examples of wearable devices include watches, glasses, contact lenses, e-textiles and smart fabrics, headbands, beanies and caps, jewelry such as rings, bracelets and hearing aid-like devices.

### DRAWINGS

FIG. 1 is a block diagram of an exemplary event and reporting wearable device system.

FIG. 2 is a block diagram of a vehicle deployed utilizing the exemplary event and reporting wearable device system.

FIG. 3 illustrates a journey informer location prediction table of possible scenarios of the wearable device in the event and reporting wearable device system.

FIG. 4 illustrates a journey informer location prediction table of possible scenarios involving a subject and a vehicle.

FIG. 5 is a journey informer location prediction table of possible scenarios involving the subject and a second vehicle.

FIG. 6 is a journey informer location prediction table of possible scenarios involving the subject and public and private transportation.

FIG. 7 is a journey informer location prediction table of possible known and/or estimated situations of the subject and associated alerts.

FIG. 8 is a continuation journey informer location prediction table of possible known and/or estimated situations of the subject and associated alerts.

FIG. 9 is an exemplary process for identifying the location of the wearable device and at least one vehicle and determining an alert.

FIG. 10 is an exemplary process for identifying the location of the wearable device and at least one linked vehicle and determining an alert.

### DESCRIPTION

### Introduction

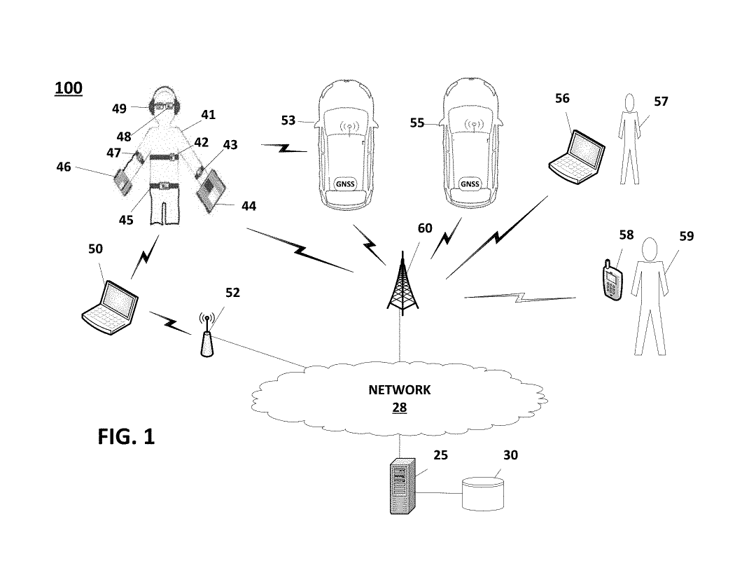

FIG. 1 is a block diagram of an exemplary wearable device journey informer system 100. A subject 41 could wear or hold one or more wearable devices, including a smart heart rate monitor 42, a smart watch 43, a tablet 44, a belt computer 45, a smart phone 46, an arm computer 47, a pair of smart glasses 48 and a smart headset 49. Yet further examples of possible wearable devices could include: a glove, a contact lens, a smart fabric, a headband, a beanie, a cap, a ring, a bracelet, an in-ear device or the like, such as is known for various applications, including acting as external human-machine interface (HMI) to a computer. Wearable technology can provide a human machine interface to a computer as well as provide sensory and scanning features not typically seen in mobile and laptop devices, such as biofeedback and tracking of physiological function.

Wearable devices can include geolocation hardware circuitry and software to provide the wearable device location, such that the wearable device can output its location. For example, the smart watch 43 can have a Global Navigation Satellite System (GNSS) and/or a regional Navigation Satellite System (NSS) receiver that calculate the location coordinates of the user device 41 to send to a computing device located in or a physically attached to a first vehicle 53. NSS is the standard generic term for satellite navigation systems that provide autonomous geo-spatial positioning with possible global coverage. The USA NSS solution, known as NAVSTAR Global Positioning System, and the Russian NSS, known as GLONASS, are the only Global NSS solutions in use at this time. They have satellites covering the entire globe. The European Union's NSS solution, known as Galileo, will also be a Global system once fully deployed. The remaining systems are regional solutions such as the Indian NSS, known as IRNSS, the Japanese NSS, known as QZSS, and the Chinese NSS, known as Beidou. The term GNSS, as provided, will encompass all satellite navigation systems referenced throughout this specification whether global or regional. Further, the term GPS, which usually refers to the USA system, will also encompass all satellite navigation systems referenced throughout this specification whether global or regional.

Alternatively, the wearable device can have a radio frequency (RF) link with a smart phone within the first vehicle 53, which may or may not be functioning as a wearable device and provide the smart phone's location to the wearable device via a download. The RF link can be Bluetooth, Near Field Communication (NFC) communications, etc., The location of the wearable device can then be inferred based on the cell phone's GNSS location.

The computing device is programmed to determine, based at least in part on a vehicle status of the first vehicle 53, a location of the first vehicle 53, and a location of the smart watch 43, a wearable device status; and to transmit the wearable device status to one or more designated recipients. In general, the wearable device status is a location (e.g., global positioning system coordinates or the like) of the smart watch 43 and/or a location of the smart watch 43 relative to the first vehicle 53, e.g., the wearable device status could be one of within the first vehicle 53 or not within the first vehicle 53, traveling at a same speed and direction as the first vehicle 53 and not traveling at a same speed and direction as the first vehicle 53, etc. Advantageously, therefore, dangerous scenarios, such as a person being lost or abducted, a vehicle being stolen, etc., may be detected.

### Exemplary System Elements

### Wearable Device

Wearable devices are typically a device incorporated into items of clothing and accessories which can comfortably be worn on the body or carried. Wearable devices can be any one of a variety of computing devices which can include a processor, a memory, a set of one or more sensors such as are known, e.g., an acceleration sensor, a temperature sensor and a GNSS sensor. The wearable device can have communications capabilities such as are known, and can connect to a first laptop 50, a vehicle network of the first vehicle 53, the network 28 via Wi-Fi, Bluetooth, Near Field Communication (NFC) communications, etc. A mobile network 60 can also communicatively connect to the wearable devices and the first laptop 50 to a network 28, e.g., the Internet. Furthermore, the first laptop 50 can connect via a wire or wirelessly to a router 52 via Wi-Fi, Bluetooth, Near Field Communication (NFC) communications, etc. The router 52 can also be communicatively connected with the network 28.

The wearable device can be a passive device, for example, an unpowered device such as a RFID device that does not contain a battery and depends on the received radio frequency (RF) signal strength of a transmitted signal from a wearable device gateway to cause the passive wearable device to generate a response. The wearable device gateway is generally known for detecting RFID devices or the like. In general, the passive wearable device can contain a serial number, typically 96 to 128 bits in length, as is known. The serial number can be read and then used by a RFID computer, or the like, to establish a one to one relationship with the passive wearable device. Since passive wearable devices do not contain a battery and depend on the wearable device gateway transmitted signal strength to generate a response, a read range is typically short, ranging from a few centimeters to typically no more than 3 meters.

The wearable device can further be a semi-passive wearable device which operates similarly to the passive wearable device, using the signal of a wearable device gateway to cause the response from a semi-passive wearable device. However, the semi-passive wearable device does have a battery, but not for generating a response, but to power electronics that are used in conjunction with its sensors, for example, a thermal sensor, a communications circuit or a GNSS receiver. Sensor readings can be incorporated into the semi-passive wearable device response signal and can include a unique identifier, e.g., the serial number.

The wearable device can be an active wearable device which contains a battery and does not depend on the signal strength of a wearable device gateway signal to generate a response. As a result, the active device can be read at much greater distances, with read distances up to 100 meters. The active wearable device may be either read-only or read/write, thus allowing data modification by the reader. Data storage is also available on active devices.

In addition to the radio frequency link, the wearable device can additionally have wireless as well as wired communication capabilities such as are known. A concern arising from use of wearable devices is the operating time or how long until its battery needs a recharge or replacement. Thus, battery size is an issue with wearable devices. For example, if the battery is large, the wearable device may be heavy, awkward to wear or unsightly. Therefore, to obtain a reasonable operational time, while incorporating a less obtrusive battery, wearable devices can utilize a low power processor, a low power memory and a low power communications circuit.

As discussed above, the wearable device may have a low power geolocation hardware and software circuitry to provide a wearer's location, such that the wearable device can output its location. For example, the smart watch 43 can provide the smart watch 43 location to the subject 41 and/or send the location information to other computing devices via cellular, Wi-Fi, Bluetooth, Near Field Communication (NFC), wired and/or wireless packet networks, etc. Alternatively, the smart watch 43 may leverage a phone to which it is paired to gain NSS location if the wearable is not fitted with a GNSS receiver. The smart watch 43 can report its location independently from the vehicle's location, as determined from the vehicle 53 navigation system or a vehicle location determined, e.g., in a known manner. For example, the vehicle 53 can have a vehicle Global Navigation Satellite System (GNSS) as part of its navigation system which can supply the vehicle 53 geographical position. The smart watch 43 location can then be used to verify that the wearer of the smart watch 43 is within the first vehicle 53 and has not wandered away from the first vehicle 53. In one example after the smart watch 43 is not verified to be within, or within a predetermined distance of, the first vehicle 53, a location alert message can be sent to a concerned parent or adult child of the user device 43, e.g., to a family member or designate 57 via a user device, such as a second laptop 56. The alert can be, for example, an email addressed to the family member 57. Additionally, the alert can be sent via text or voice to the subject 41 (wearer of the device), a designated 59 user device, such as a smart phone 58.

The wearable device, as is known, can include an accelerometer, also known as an acceleration sensor, and can detect a magnitude and direction of acceleration (or g-force) as a vector quantity, and can be used to sense orientation and acceleration in a known manner. The wearable device's accelerometer can send acceleration information to other computing devices in much the same way as the aforementioned alert, which is via cellular, Wi-Fi, Bluetooth, Near Field Communication (NFC), wired and/or wireless packet networks, etc. If the subject 41 of the smart watch 43 were to fall down or suddenly decelerate, which would occur in a vehicular accident, the acceleration sensor would detect such a change and report the acceleration sensor data to other computing devices in the manner as described above. For example, in addition to a collision detection and reporting system in the first vehicle 53, data indicating rapid decelerations followed by zero accelerations can be sent from the smart watch 43 to a computer 12 in the first vehicle 53. Programming in the first vehicle 53 computer 12 can detect the change in the acceleration sensor data and summon aide to the first vehicle 53 location, as determined by either the first vehicle 53 navigation system, a vehicle cellular tower triangulation device or the smart watch 43 GNSS sensors.

### Vehicles

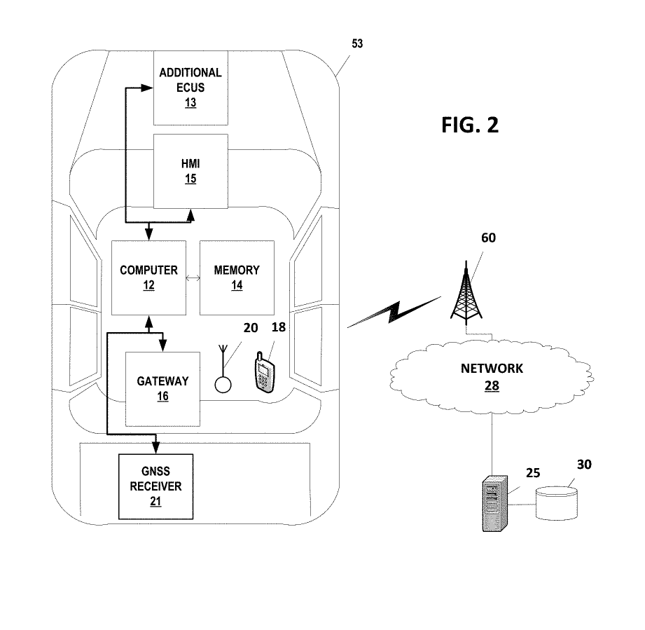

Now with reference to FIGS. 1 and 2, the first vehicle 53 includes a computer 12 with a processor and a memory 14, the memory 14 including one or more forms of computer-readable media, and storing instructions executable by the processor for performing various operations, including as disclosed herein. For example, the computer 12 generally includes, and is capable of executing, instructions to detect the presence of a wearable device 20 and a user device 18. The wearable device 20 depicts the wearable devices described above and any as is known. The computer 12 can send and receive, to the user device 18 and/or to the wearable device 20, messages that alternatively or additionally may be sent or received to the human machine interface (HMI) 15.

The computer 12 is configured, i.e., includes programming and hardware such as is known, for communicating with one or more processing units 25 (computer) and typically including or being coupled to a data store 30 via a gateway 16 of the first vehicle 53. The gateway 16 can be a telematics unit or the like provided for sending and receiving information via the network 28, e.g., in a known manner. The wearable device 20, the user device 18, and the first vehicle 53 gateway 16 can communicate with each other, as described below, and may include various wired and/or wireless networking technologies, e.g., cellular, Wi-Fi, Bluetooth, Near Field Communication (NFC), wired and/or wireless packet networks, etc. Further, the computer 12 generally includes instructions for exchanging data, e.g., from one or more wearable devices 20 and/or user devices 18 and/or the HMI 15, which may be one or more of an interactive voice response (IVR) system, a graphical user interface (GUI) including a touchscreen or the like, etc.

The first vehicle 53 can have various electronic control units (ECUs) 13 for monitoring and controlling various vehicle 10 electrical and electromechanical systems. The ECUs can be incorporated into the first vehicle 53 and provide and request information to and from the occupant via the HMI 15, the wearable device 20 or the user device 18. For example, ECUs 13 can include a navigation ECU with a vehicle cellular tower triangulation device, a vehicle dead reckoning device or a vehicle GNSS device to determine a vehicle location. Other ECUs can include a safety ECU, a powertrain ECU, and an entertainment ECU, just to name a few. Each ECU 13 can contain a processor and a memory, the memory storing instructions to be executed on the processor to perform each particular ECU's operation(s), as well as instructions to communicate with other ECUs and devices and generate the vehicle status. For example, the vehicle status can include velocity, ambient temperature, direction of travel, fuel level, etc. Additionally, a designated vehicle 55 can be comparably equipped to the first vehicle 53. The designated vehicle 55 is a possible second vehicle in which the wearer 41 can be located.

### User Device

The user device 18 can be a smart phone, a tablet or the like, and/or operations ascribed herein to the user device 18 can be performed by the wearable device 20. Some user devices 18, as is known, can have a telecommunications connection to an external cellular network, as well as local network capability. For example, the user device 18 can be connected to a cellular telephone network for voice communications as well as having a data connection to an external network, such as the Internet. The local network capability can be provided by Wi-Fi, Bluetooth, Near Field Communication (NFC) communications, etc. The user device 18 can include geolocation hardware and software, as is known, which allows the user device 18 to obtain positional information and provide the user device 18 location.

The user device 18, typically a mobile device carried by a user, may be any one of a variety of computing devices with a processor, a memory, and a GNSS, as well as communications circuitry. For example, the user device 18 may be a portable computer, tablet computer, a smart phone, etc., that includes capabilities for wireless communications using IEEE 802.11, Bluetooth, and/or cellular communications protocols. Further, the user device 18 may use such communication capabilities to communicate via the network 28 with the vehicle computer 12 or to the processing unit 25.

### Server

The processing unit 25 may be a single computer and can be positioned throughout the wearable device journey informer system 100 or the processing unit 25 can be a cluster of computers, each generally including at least one processor and at least one memory, the memory storing instructions executable by the processor, including instructions for carrying out various steps and processes described herein. The processing unit 25 may include or be communicatively coupled to a data store 30 for storing data. In general, the processing unit 25 may be used for a variety of purposes, e.g., receive ongoing location data from the first vehicle 53 and the wearable device 20 and store the data in a data store 30 as vehicle tracking data for future routing, potential waypoints, weather and traffic information, etc. Thus, one possible operation of the processing unit 25 is to receive an indication from the first vehicle 53 computer 12 via the network 28 that the first vehicle 53 subject 41 is in the first vehicle 53, and that the first vehicle 53 ignition switch is on.

### Logic Table Examples

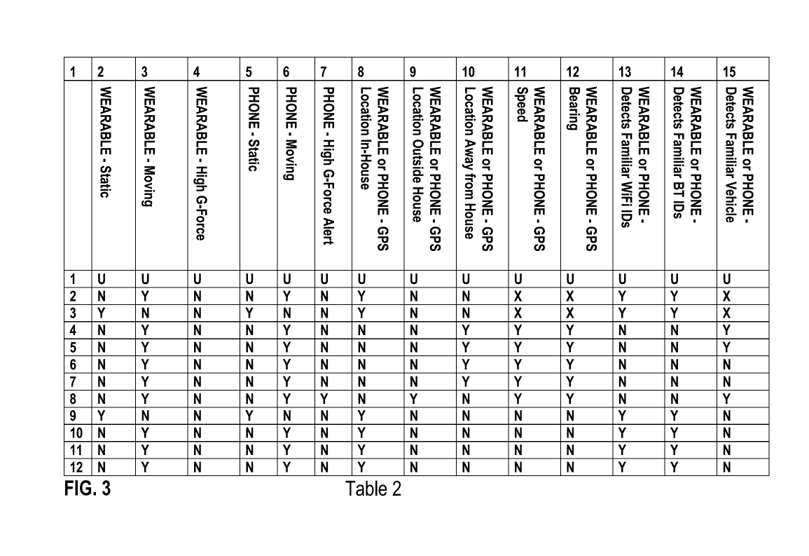

FIGS. 3-8 are an exemplary set of tables of journey event tables with regards to the subject 41 of the wearable device 20 and their location to the vehicle 53. In general, journey event tables provide information about current or past locations and/or states of devices 18, 20 and/or vehicles 53, 55. Journey event tables can provide information used to determine if a subject 41, device 18, 20, and/or vehicle 53, 55 is in an expected and/or desired location. Accordingly, journey event tables can be used to determine to send a message in the event that a subject 41, device 18, 20, and/or vehicle 53, 55 is not in an expected and/or desired location.

The legend to the set of tables illustrated in FIGS. 3-8 is shown in Table 1 below.

TABLE 1

| | |
|---|---|
| Y | Positive State |
| N | Negative State |
| U | Condition Unknown or Data Unavailable |
| X | Don't Care or Not Relevant |

Now with reference to FIG. 3, the top row of the table 2 lists exemplary scenarios of the wearable device 20. The first column is a key row number which will be referenced across all the tables. Columns two and three indicate whether the wearable device 20 is moving or static (i.e., substantially not in motion). For example, a wearable device 20 or smartphone 46 can determine if it is moving or static by analyzing data from an accelerometer that could be included in the device 20, or 46. Column four of Table 2 indicates whether the wearable device 20 accelerometer detects a high G-Force (e.g., above a predetermined threshold), possibly indicating a vehicular accident or a fall. Columns five and six indicate whether the smart phone 46 is moving or static. Column seven indicates whether the smart phone 46 detects a high G-Force. Columns eight through ten refer to the location of either the wearable device 20 or the smart phone 46. Columns eleven and twelve indicate speed data and bearing data are available from either the wearable device 20 or the smart phone 46. Column thirteen indicates that either the wearable device 20 or the smart phone 46 is familiar with the current Wi-Fi signal. Column fourteen indicates that either the wearable device 20 or the smart phone 46 is familiar with the current Bluetooth signal. Column fifteen indicates that either the wearable device 20 or the smart phone 46 is familiar with the current vehicle.

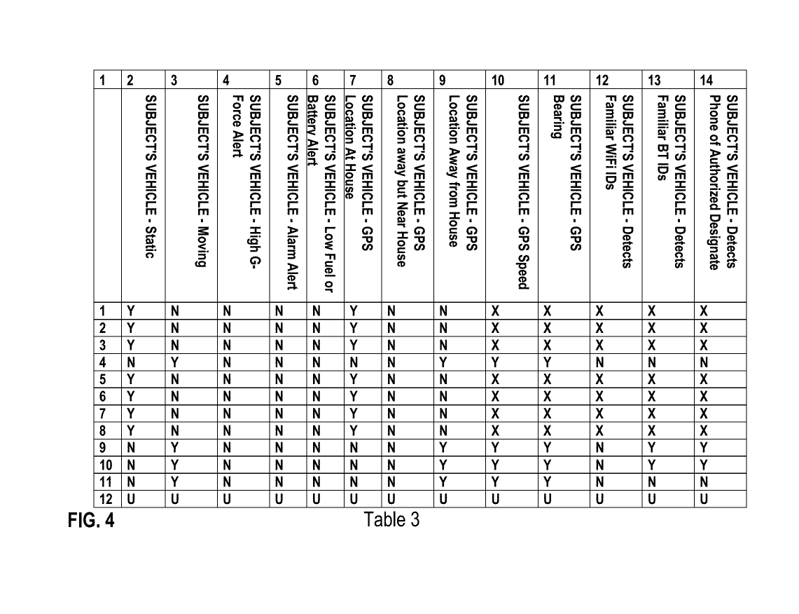

Now with reference to FIG. 4, the top row of the table 3 lists exemplary scenarios of the subject 41 and the first vehicle 53. The first column is a key row number which will be referenced across all the tables. Columns two and three indicate whether the vehicle 53 is moving or static. Column four indicates whether the vehicle 53 accelerometer detects a high G-Force. Column five indicates whether any vehicle alarms have been triggered. Column six indicates whether the vehicle is low in fuel and/or the vehicle's battery is low. Column seven through nine refer to the location of either the vehicle 53. Column ten and eleven indicate speed data and bearing data are available from the vehicle 53. Column twelve indicates that the vehicle 53 is familiar with the current Wi-Fi signal. Column thirteen indicates that the vehicle 53 is familiar with the current Bluetooth signal. Column 14 indicates the vehicle 53 detects the smart phone 58 of the designated 59.

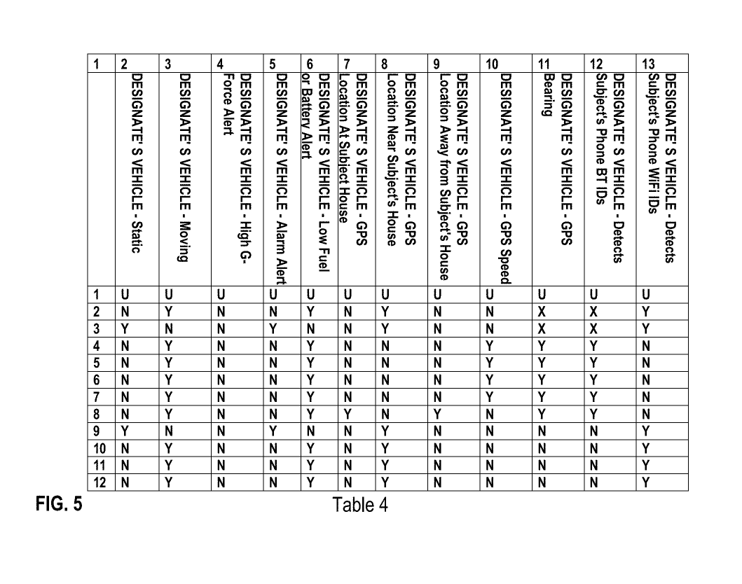

Now with reference to FIG. 5, the top row of the table 4 lists exemplary scenarios of the designated vehicle 55. The first column is a key row number which will be referenced across all the tables. Columns two and three indicate whether the designated vehicle 55 is moving or static. Column four indicates whether the designated vehicle 55 accelerometer detects a high G-Force. Column five indicates whether any vehicle alarms have been triggered. Column six indicates the designated vehicle 55 is low in fuel and/or the vehicle's battery is low. Columns seven through nine refer to the location of either the designated vehicle 55. Column ten and eleven indicate speed data and bearing data are available from the designated vehicle 55. Column twelve indicates that the designated vehicle 55 detects the smart phone 46 Bluetooth ID. Column thirteen indicates that the designated vehicle 55 detects the smart phone 46 Wi-Fi ID.

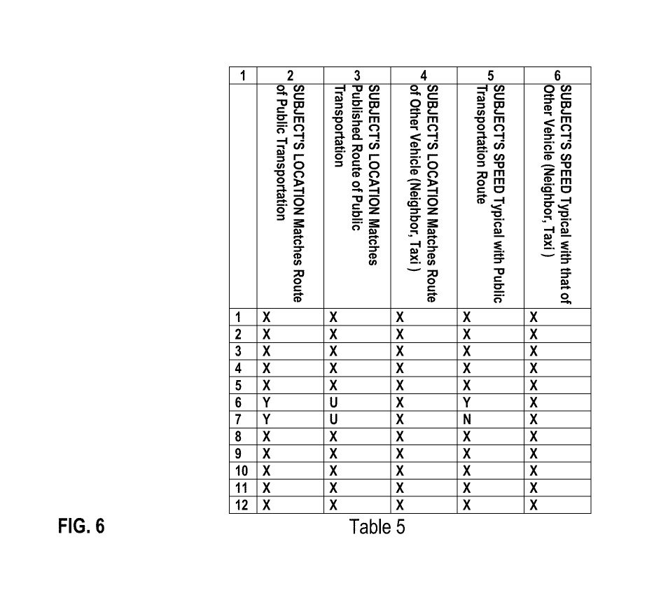

Now with reference to FIG. 6, the top row of the table 5 lists exemplary scenarios for public transportation. The first column is a key row number which will be referenced across all the tables. Column two indicates the subject 41 location matches a public transportation route. For example, the subject 41 could be on a public bus or train. Column three indicates the subject 41 location matches a published route. For example, the subject 41 could be on a regularly scheduled public bus or train. Column 4 indicates the subject 41 location matches the route of other vehicles, for example, a private vehicle or a taxi. Column five indicates that the subject 41 speed is typical for public transportation. Column six indicates that the subject 41 speed is typical of other vehicles, for example, a private vehicle or a taxi.

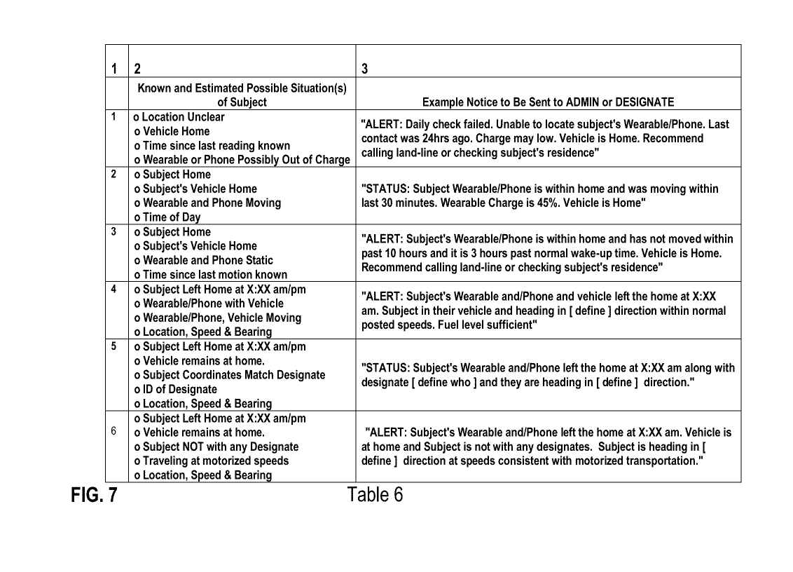

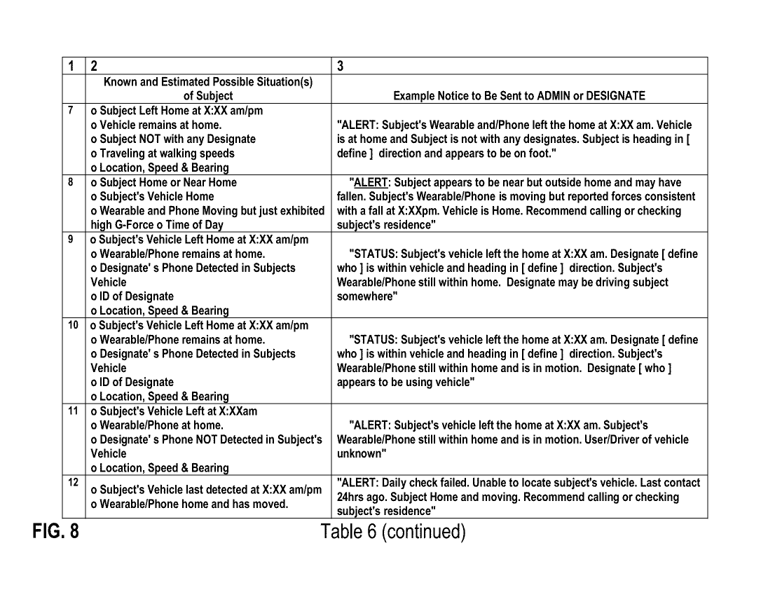

Now with reference to FIGS. 7 and 8, a subject status can be obtained from the top row of the table 6, which lists exemplary scenarios of the possible known and/or estimated situations of the subject 41 and associated possible alerts. The first column is a key row number which will be referenced across all the tables. For example, referring to FIG. 3 and key row 1, all column entries are unknown. Continuing with FIG. 4 and key row 1, the subject 41 vehicle 53 is static and the other columns are negative or do not apply. Continuing with the table of FIG. 5 and the same key row 1, none of the columns apply because the subject 41 is not in the designated vehicle 55. Still continuing with the current example, the table in FIG. 6 does not apply because the subject 41 is not using public or private transportation. Continuing with the current example and referring to the key row 1 and column 2 of FIG. 7, it may be deduced that the subject 41 location is unclear, the vehicle 53 is home, the time since the last reading is known and the wearable device 20 or the smart phone 46 is out of charge. An alert can be sent indicating one or more of, for example, “Daily check failed. Unable to locate subject's Wearable/Phone. Last contact was 24 hours ago. Charge may low. Vehicle is Home. Recommend calling land-line or checking subject's residence.”

### Exemplary Process Flows

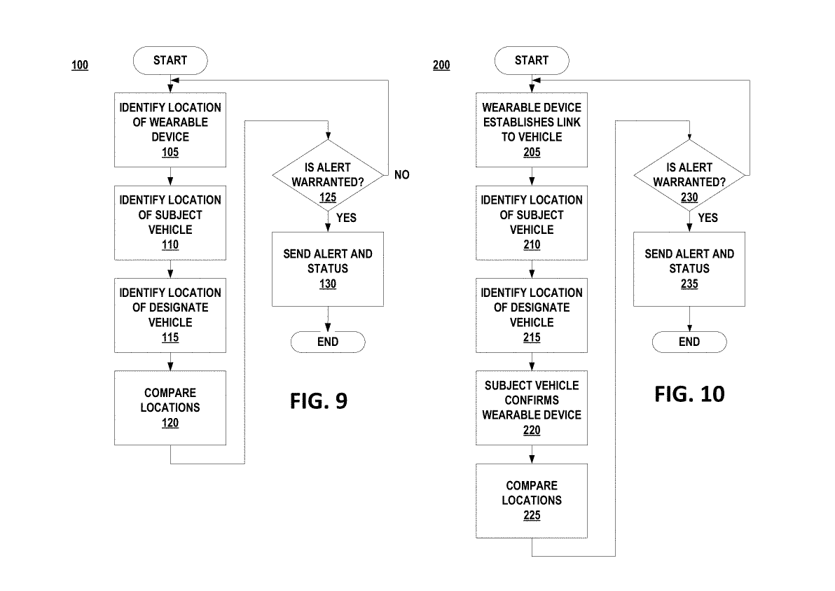

FIG. 9 is an exemplary process 100 for identifying a location of a wearable device 20 and at least one vehicle 53, 55.

The process 100 begins in a block 105, in which the wearable device 20 determines its location and reports the location information to a computer 12. The wearable device 20 can determine its location from GNSS, Wi-Fi or cellular, etc. The wearable device 20 can then send the location to the computer via Wi-Fi, landline, cellular, etc. The computer 12 can be located anywhere including within the vehicle 53.

Next, in a block 110, the vehicle 53 determines its location and reports the location information to the computer 12. The vehicle 53 can derive its location from GNSS, Wi-Fi or cellular, etc. The vehicle 53 can then send the location to the computer 12 via a cellular connection, for example.

Next, in a block 115, the designated vehicle 55 determines its location and reports the location information to the computer 12. The designated vehicle 55 can derive its location from GNSS, Wi-Fi or cellular, etc. The designated vehicle 55 can then send the location to the computer via a cellular connection, for example.

Next, in the block 120, the computer compares the locations of the wearable device 20, the vehicle 53 and the designated vehicle 55, and compares the locations to parameters in the journey informer location predictions tables. For example, referring to FIG. 3 and key row 2, the subject 41 wearable device 20, such as the smart watch 43 and the smart phone 46 are moving and located at the subject 41 home and the Wi-Fi and Bluetooth IDs are familiar. Continuing with FIG. 4 and key row 2, the subject 41 vehicle 53 is static and at the subject 41 house along with the wearable device 20. The designated table of FIG. 5 does not apply. Still continuing with the current example, the table in FIG. 6 does not apply because the subject 41 is not using public or private transportation. Continuing with the current example and referring to the key row 2 and column 2 of FIG. 7, it may be deduced that the subject 41 location is home, the vehicle 53 is home, the wearable device 20 or the smart phone 46 is moving. A status can be sent indicating that the “Subject Wearable/Phone is within home and was moving within last 30 minutes. Wearable Charge is 45%. Vehicle is Home”

Next, in the block 125, the computer 12 determines if an alert message is to be sent. For example, an alert message can be sent when subject 41 life or safety are at issue. For example, when a daily check fails and the system is unable to locate subject 41 wearable device 20. Alternatively, a status message can be sent indicating that the subject 41 is “Okay.” If the alert message is determined to be sent, the process 100 continues to next in a block 130, else the process 100 return to in the block 105.

Next, in a block 130, the alert message is sent. For example, the alert message can be sent to the family member 57, the designated 59 or the subject 41. The alert can be a text, a voice to a phone, an email, etc. The process 100 then ends.

FIG. 10 is an exemplary process 200 for identifying the location of the wearable device 20 and at least one linked vehicle 53, 55.

The process 200 begins in a block 205, in which the wearable device 20 connects with the vehicle 55. The connection can be via Wi-Fi or Bluetooth.

Next, in a block 210, the vehicle 53 determines its location and reports the location information to the computer. The vehicle 53 can derive its location from GNSS, Wi-Fi or cellular, etc. The vehicle 53 can then send the location to the computer via a cellular connection, for example.

Next, in a block 215, the designated vehicle 55 determines its location and reports the location information to the computer. The designated vehicle 55 can derive its location from GNSS, Wi-Fi or cellular, etc. The designated vehicle 55 can then send the location to the computer via a cellular connection, for example.

Next, in a block 220, the computer confirms the location of the wearable device 20.

Next in a block 225, the computer compares the locations of the vehicle 53 and the designated vehicle 55, and then further compares the locations to parameters in the journey informer location predictions tables.

Next, in a block 230, the computer 12 determines if an alert message needs to be sent. For example, an alert message can be sent when subject 41 life or safety are at issue. For example, when a daily check fails and the system is unable to locate subject 41 wearable device 20. Alternatively, a status message can be sent indicating that the subject 41 is “Okay.” If the alert messages are determined to be sent, the process 200 continues to next in a block 235, else the process 200 returns to in the block 205.

Next, in the block 235, an alert message is sent. For example, the alert message can be sent to the family member 57 or to the designated 59. The alert can be a text, a voice to a phone, an email, etc. The process 200 then ends.

### CONCLUSION

As used herein, the adverb “substantially” means that a shape, structure, measurement, quantity, time, etc. may deviate from an exact described geometry, distance, measurement, quantity, time, etc., because of imperfections in materials, machining, manufacturing, etc.

The term “exemplary” is used herein in the sense of signifying an example, e.g., a reference to an “exemplary widget” should be read as simply referring to an example of a widget.

Computing devices such as those discussed herein generally each include instructions executable by one or more computing devices such as those identified above, and for carrying out blocks or steps of processes described above. For example, process blocks discussed above are embodied as computer-executable instructions.

Computer-executable instructions may be compiled or interpreted from computer programs created using a variety of programming languages and/or technologies, including, without limitation, and either alone or in combination, Java™, C, C++, C#, Visual Basic, Java Script, Python, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A computing device that includes a processor and a memory, the memory storing instructions executable by the processor such that the device is programmed to:
identify a vehicle location and a vehicle status;
determine a location of a wearable device independently of identifying the vehicle location; and
based at least in part on the vehicle status, the location of the vehicle and the location of the wearable device
send a message via a network.

2. The device of claim 1, further programmed to:
identify the wearable device of a subject in the memory;
identify the vehicle associated with the subject in the memory;
identify a second vehicle associated with the subject in the memory;
identify a public transportation route with the subject in the memory; and
determine the message from a subject status in the memory.

3. The device of claim 1, further programmed to:
identify a second vehicle location and a second vehicle status of a vehicle; and
determine, based at least in part on the second vehicle location and the second vehicle status, the message.

4. The device of claim 1, further programmed to:
identify a public transportation route; and
determine, based at least in part on the location of the wearable device and the public transportation route, the message.

5. The device of claim 1, wherein the location of the vehicle is determined from at least one of a vehicle Global Navigation Satellite System (GNSS), a vehicle cellular tower triangulation device, and a vehicle dead reckoning device.

6. The device of claim 1, wherein the location of the wearable device is identified from at least one of a GNSS sensor and a download from a smart phone.

7. The device of claim 1, wherein the wearable device is at least one of a watch, a smart phone, a pair of smart glasses, a glove, a contact lens, a smart fabric, a headband, a beanie, a cap, a ring, a bracelet, and an in-ear device.

8. The device of claim 1, further programmed to:
identify a wearable device status from the wearable device; and
determine, based at least in part on the wearable device status, the message.

9. The device of claim 8, wherein the wearable device status includes accelerometer information.

10. The device of claim 8, further programmed to:
identify periodically at least the vehicle status and the wearable device status;
determine any changes in at least the vehicle status and the wearable device status; and
based at least in part on the vehicle status and the wearable device status, the message.

11. A method, comprising:
identifying a vehicle location and a vehicle status of a vehicle;
identifying a wearable device;
identifying a wearable device location of the wearable device independently of identifying the vehicle location; and
based at least in part on the vehicle status, the vehicle location and the wearable device location,
sending a message via a network.

12. The method of claim 11, further comprising:
identifying the wearable device of a subject in a memory;
identifying the vehicle associated with the subject in the memory;
identifying a second vehicle associated with the subject in the memory;
identifying a public transportation route with the subject in the memory; and
determining the message from a subject status in the memory.

13. The method of claim 11, further comprising:
identifying a second vehicle location and a second vehicle status of a vehicle; and
determining, based at least in part on the second vehicle location and the second vehicle status, the message.

14. The method of claim 11, further comprising:
identifying a public transportation route; and
determining, based at least in part on the wearable device location and the public transportation route, the message.

15. The method of claim 11, wherein the vehicle location is identified from at least one of a vehicle Global Navigation Satellite System (GNSS), a vehicle cellular tower triangulation device and a vehicle dead reckoning device.

16. The method of claim 11, wherein the wearable device location is identified from at least one of a GNSS sensor and a download from a smart phone.

17. The method of claim 11, wherein the wearable device is at least one of a watch, a smart phone, a pair of smart glasses, a glove, a contact lens, a smart fabric, a headband, a beanie, a cap, a ring, a bracelet, and an in-ear device.

18. The method of claim 11, further comprising:
identifying a wearable device status from the wearable device; and
determining, based at least in part on the wearable device status, the message.

19. The method of claim 18, wherein the wearable device status includes accelerometer information.

20. The method of claim 18, further comprising:
identifying periodically the vehicle status and the wearable device status;
determining changes in at least the vehicle status and the wearable device status; and
sending the message, wherein the message is based at least in part on the vehicle status and the wearable device status.
